(19) United States
(12) Patent Application Publication
(10) Pub. No.: US 2016/0175872 A1
(43) Pub. Date: Jun. 23, 2016

(54) SHOWER ACCESSORY

(71) Applicant: David C. Hagon, Nashville, MI (US)

(72) Inventor: David C. Hagon, Nashville, MI (US)

(21) Appl. No.: 14/973,285

(22) Filed: Dec. 17, 2015

Related U.S. Application Data
(60) Provisional application No. 62/096,138, filed on Dec. 23, 2014.

(51) Int. Cl. B05B 15/06; A47K 3/28; B05B 1/18

(52) U.S. Cl. CPC B05B 15/06; B05B 1/185; A47K 3/281

(57) ABSTRACT

A cup shaped holder defining a wall and a bottom and having a sufficient size opening in the top to hold a hand held shower head downward facing position is disclosed. The cup shaped holder contains a U-shaped opening in one side of the wall of a sufficient size to allow placing the handle of a hand held shower head with the shower head facing downward into the holder. The bottom defines a least one drain hole and a wall connector is on the outside of the site wall across from the U-shaped opening. The holder provides to place in the shower for placing the shower head face down while the water is running and before and after its use. The holder prevents unnecessary spraying of water while the water is on but the spray head is not being used.

### CLAIM OF PRIORITY

This application claims the benefit of the filing date of U.S. provisional patent application Ser. No. 62/096,138 filed Dec. 23, 2014

### FIELD OF INVENTION

This invention relates to a holder for a hand held shower head.

### BACKGROUND OF THE INVENTION

Hand held shower heads with handles affixed to a flexible shower hose have been designed to be clamped to a support above a person's head and can be held by hand if removed from a clamped position. When placed this way the water is usually left running of most likely shut off when a person is soaping up, washing or shampooing. If the shower head is held by a person, only one hand can be used unless the water is shut off and the showerhead is laid down or reconnected to a clamp. If the showerhead is laid down or left to dangle while the water is left on, the water simply splashes around the shower.

### SUMMARY OF THE INVENTION

In the present invention, a cup shaped holder is provided for a hand held shower head which allows the water to be left on during use or while warming up but which prevents the water from splashing around the shower. The holder comprises a wall, an open top and a bottom and having a sufficient size to hold the shower head of a hand held shower head such that it sprays water into the cup shaped holder. The holder contains a U-shaped opening in one side of the wall of a sufficient size to allow placing the handle with the shower head facing into the holder, at least one drain hole in the bottom of the holder, and a all connector on the outside of the side wall across from the U-shaped opening. The holder provides a place in the shower for placing the shower head while the water is running and before and after its use.

Advantages of this invention will become apparent from a consideration of the drawings and ensuing description.

### BRIEF DESCRIPTION OF THE DRAWINGS

FIG. 1 shows a shower head containing a handle and flexible hose seated in one embodiment of the shower accessory of the invention attached to a shower wall.

FIG. 2 shows an isometric view of the shower accessory showing in this embodiment a piece of hook-loop fabric as the wall connector.

FIG. 3 shows a top plane view of the shower accessory.

In the drawings not all like parts are numbered but it is readily apparent that the same reference number refers to like part.

### DETAILED DESCRIPTION

### LIST OF REFERENCE NUMBERS

1. Hand held shower head

2. Showerhead of 1

3. Handle of shower head

4. Flexible water hose attached to handle 3

10. Holder for hand held shower head

11. Sidewall of holder 10

11a. Flat portion of sidewall 11

12. U-Shaped opening in side wall

13. Wall connector

14. Bottom of holder

15. Drain hole

Reference to the drawings will show that in each of the figures like parts bear the same numerical designation.

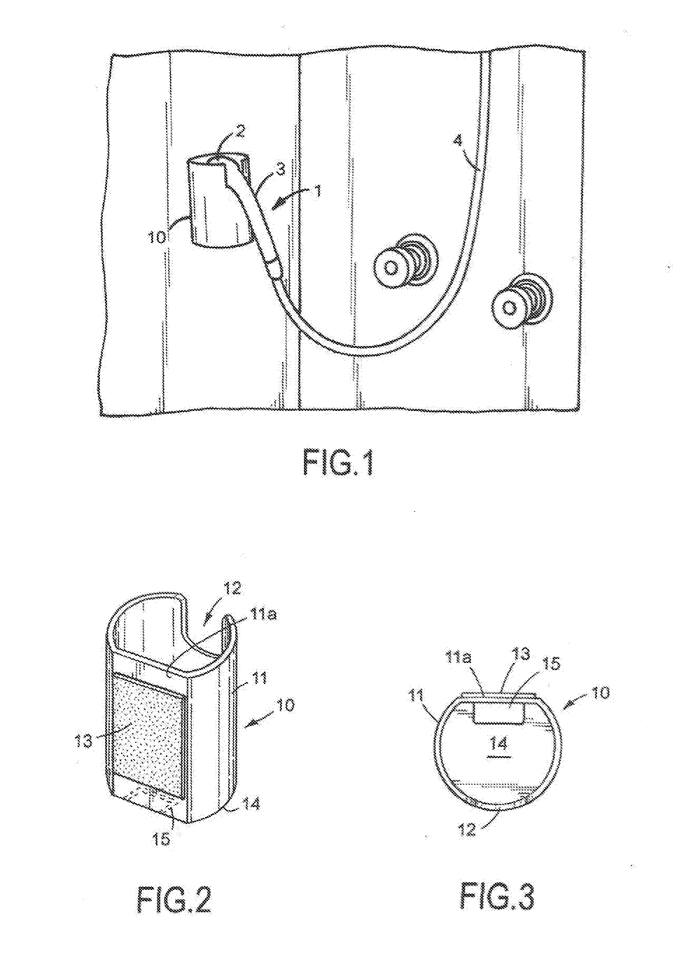

In the preferred embodiment, band held shower head 1 comprises a spray head 2, a handle 3 attached to spray head 2, and a flexible water hose 4 affixed to handle 3. FIG. 1 illustrates an embodiment of a holder 10 of the invention attached to the side wall of a shower, with the hand held shower head 1 placed in the holder with spray head 2 facing downward into the cup shaped holder 10.

FIGS. 2 and 3 illustrate an isometric, and top view of one embodiment of a holder 10 having a cylindrical cup shape. The side wall 11 of the holder defines U-shaped opening 12 running down the side of the wall 11. The opening 12 is sized so that a handle 3 of a hand held shower head 1 can be slipped into the opening 12 with the spray head 2 facing down inside the holder 10. The length of the holder 10 from top to bottom is preferably sufficiently deep that when water is spraying out from the spray head 2 it does not splash over the top edge of the holder 10.

Wall 11 of holder 10 is flat at 11a for about 1 to 1½ inch on the side opposite U-shaped opening 12. A wall connector 13 is secured to the exterior of flat wall portion 11a. Connector 13 facilitates the attachment of the holder 10 to the wall of a shower at a convenient location. In the embodiment illustrated in the figures the connector is a strip of hook/lope material such as sold under the trademark VELCRO. The holder can be attached to a mating strip attached to the wall of a shower. Other types of wall connectors can be employed such as, suction cups, adhesives, fasteners such as screws, nut bolt connections and the like. It is preferred the thickness of the connector be thin so the holder sits near to the wall of a shower.

The holder also contains a bottom 14 which defines at least one drain hole 15. The drain hole(s) are of a sufficient size so that water spraying from a hand held shower head placed in the holder drains out from the bottom of the holder 10 at a sufficient rate that the water does not splash over the top edge of the holder. In a preferred embodiment the drain hole(s) are preferably formed in bottom 14 on the side where the connector 13 is placed so water exiting from an operating hand held, shower head 1 runs down the shower wall that the holder 10 is connected to and onto the shower floor. This reduces splashing of water in the shower. This is also why in a preferred embodiment the connector is thin so the holder can be placed close to a shower wall. In the preferred embodiment, only one drain hole 15 is provided in bottom wall 14, adjacent sidewall portion 11a, which in turn is positioned against the shower wall via connector 13.

The embodiments show a cylindrical cup shaped holder 10. Other shapes can be used. Any convenient shape, round, oblong, rectangular, square or the li can be used provided the cross sectional dimensions hold the shower head in a downward facing position. Round is preferred since most hand held shower heads are round. When round holders are used, the side to be attached to the wall may be slightly flattened to improve a secure fit to the wall.

The holder 10 can be constructed of any suitable material. Plastic (e.g. polyvinyl chloride, high density polyethylene, polypropylene, polystyrene, and polycarbonate), metal such as aluminum, chromed metal or plastic, or the like can be employed.

The holder 10 can be permanently or detachably attached to a shower wall with suitable wall connectors and can be attached to the shower wall at convenient locations depending on the wishes of the user.

### EXAMPLE

One embodiment of a holder 10 of the invention shown in the figures was constructed from a cylindrical piece of polyvinyl chloride plastic pipe. The outside diameter of the holder was four inches and the length (height) was 6 inches. A vertically placed U-shaped opening was cut from the wall 11 that was 1.5 inches wide by 2.25 inches long from the top edge of the cylinder. The top edge corners of the opening were chamfered at about 45° to the vertical so as to be about 0.25 inch long. The bottom of the cutout portion was rounded having a 0.75 inch radius. An about 1 to 2 inch wide by about 5 to 6 inch long strip of VELCRO brand hook loop material having an adhesive side was attached on the outside wall of the cylinder across from the U-shaped opening. The long side of the strip was vertically attached to the cylinder leaving a 0.5 inch of the wall exposed at the top and bottom of the cylinder holder. A round piece of polyvinyl chloride plastic was cut to fit the inside diameter of the cylinder. A drain hole 15 in the bottom of said holder approximately 1 to 1.5 inches long and approximately ½ to 1 inch wide, and a wall connector on the outside of said side wall, across from said U-shaped opening is cut out (or molded out) from the bottom 14. The bottom was glued into the bottom side of the cylinder and positioned so the notch formed a drain hole 15 directly below the VELCRO strip. A second smaller drain hole (one sixteenth inch diameter) was drilled through the bottom about two thirds the distances across from the larger notch shaped drain hole 15.

The holder containing the VELCRO strip was attached to the wall of a shower by pressing it to a similar strip adhered to the wall. A hand held shower head was placed face down into the attached holder and the shower water turned on. The holder held the shower head securely. The spray from the shower head drained from the holder and flowed substantially down the shower wall causing little splashing.

Various modifications can be made without departing from the spirit of this invention. The dimensions set forth in this disclosure are given only as examples.

1. A. hand held shower head holder for mounting in a shower, comprising: a cup shaped holder including a wall with an upper edge, an open top and a bottom; a generally U-shaped opening in one side of said wall, extending to said upper edge of said side wall; said generally U-shaped opening being of a sufficient size to allow placing the handle of a shower head into said U-shaped opening, with said shower head facing into said holder; at least one drain hole in the bottom of said holder; and a wall connector on the outside of said side wall, across from said U-shaped opening; whereby said holder can be placed on the wall of a shower for holding a hand held shower head while water is running through it, with the water spraying into said cup holder and running out said bottom hole, to thereby prevent the running water from splashing around the shower.

2. The hand held shower head holder of claim 1 wherein: said drain hole is formed in said bottom near said sidewall portion where said wall connector is positioned, whereby water exiting from an operating hand held shower head runs down the shower wall to which said holder is attached.

3. The hand held shower head holder of claim 2 wherein: there is only one said drain hole in said cup shaped holder.

4. The hand held shower head holder of claim 3 wherein: said holder wall is flat on at least a portion of said wall which is opposite said U-shaped opening; said wall connector being secured to the exterior of flat wall portion.

5. The hand held shower head holder of claim 4 wherein: said wall connector is a strip of hook/loop material which can be attached to a. mating strip attached to the wall of a shower.

6. The hand held shower head holder of claim 5 wherein: said cup holder wall is generally cylindrical.

7. The hand held shower head holder of claim 2 wherein: said holder wall is flat on at least a portion of said wall which is opposite said U-shaped opening; said wall connector being secured to the exterior of flat wall portion.

8. The hand held shower head holder of claim 7 wherein: said wall connector is a strip of hook/loop material which can he attached to a mating strip attached to the wall of a shower,

9. The hand held shower head holder of claim 8 wherein: said cup holder wall is generally cylindrical.

10. The hand held shower head holder of claim 1 wherein: said holder wall is flat on at least a portion of said wall which is opposite said U-shaped opening; said wall connector being secured to the exterior of flat wall portion.

11. The hand held shower head holder of claim 10 wherein: said wall connector is a strip of hook/loop material which can he attached to a mating strip attached to the wall of a shower.

12. The hand held shower head holder of claim 1 wherein: corners of said generally U-shaped opening at said upper edge of said sidewall are chamfered.

13. The hand held shower head holder of claim 11 wherein: said cup holder wall is generally cylindrical.

14. The hand held shower head holder of claim 11 wherein: said cup holder wall is generally cylindrical.

15. A hand held shower head holder for mounting in a shower, comprising: a cup shaped holder including a wall, an open top and a bottom, said holder having a diameter of about 4 inches and a height of about 6 inches; a U-shaped opening in one side of said wall of about 1.5 inches width and about 2.25 inches long from the top edge of said wall; at least one drain hole in the bottom of said holder approximately 1 to 1.5 inches long and approximately ½ to 1 inch wide; and a wall connector on the outside of said side wall, across from said U-shaped opening; said drain hole being formed in said bottom near said sidewall portion where said wall connector is positioned, whereby water exiting from an operating hand held shower head runs down the shower wall to which said holder is attached.

16. The hand held shower head holder of claim 15 wherein: said holder wall is flat on at least a portion of said wall which is opposite said U-shaped opening; said wall connector being secured to the exterior of flat wall portion.

17. The hand held shower head holder of claim 16 wherein: said wall connector is a strip of hook/loop material which can be attached to a. mating strip attached to the wall of a shower.

18. The band held shower head holder of claim 17 wherein: said cup holder wall is generally cylindrical.

19. The band held shower head holder of claim 18 wherein: corners of said generally U-shaped opening at said upper edge of said sidewall are chamfered.

20. The hand held shower head holder of claim 15 wherein: there is only one said drain hole in said cup shaped holder.
